(19) United States
(12) Patent Application Publication
(10) Pub. No.: US 2026/0121184 A1
(43) Pub. Date: Apr. 30, 2026

(54) Cap Assembly Including a Sealing Gasket, Battery Cell Including the Same and Manufacturing Method of the Battery Cell

(71) Applicant: SK On Co., Ltd., Seoul (KR)

(72) Inventor: Hoemin CHEONG, Daejeon (KR)

(21) Appl. No.: 19/367,944

(22) Filed: Oct. 24, 2025

(30) Foreign Application Priority Data
Oct. 28, 2024 (KR) 10-2024-0148834

(51) Int. Cl. H01M 50/186; H01M 10/04; H01M 50/167; H01M 50/171; H01M 50/184; H01M 50/198; H01M 50/342; H01M 50/536

(52) U.S. Cl. CPC H01M 50/186; H01M 10/049; H01M 50/167; H01M 50/171; H01M 50/184; H01M 50/198; H01M 50/3425; H01M 50/536; H01M 2200/20

(57) ABSTRACT

The present disclosure provides a battery cell including: a cell case including a sidewall having an accommodating space and an end plate; an electrode assembly; and a cap assembly sealing the cell case, wherein the cap assembly includes: a cap plate covering one side of the accommodating space; and a sealing gasket disposed between the cap plate and the cell case, wherein the cap plate includes a first surface facing the accommodating space, a second surface opposite the first surface, and a third surface connecting the first surface and the second surface, the second surface includes an edge region and a central region, and the sealing gasket is formed integrally with the cap plate by insert injection, so that at least a portion thereof is in contact with the edge region.

### CROSS-REFERENCE TO RELATED APPLICATION(S)

This patent document claims the priority and benefits of Korean Patent Application No. 10-2024-0148834 filed on Oct. 28, 2024, the disclosure of which is incorporated herein by reference in its entirety.

### TECHNICAL FIELD

The disclosure and implementations disclosed in this patent document generally relate to a cap assembly including a sealing gasket, a battery cell including the same and a manufacturing method of the battery cell.

### BACKGROUND

Secondary battery cells, unlike primary batteries, offer the convenience of being rechargeable and rechargeable, and are attracting significant attention as power sources for various mobile devices, electric vehicles, and energy storage devices.

Secondary battery cells may be manufactured as pouch-type or can-type cells. The pouch-type cells have a structure in which an electrode assembly is accommodated within a flexible cell case (pouch). The can-type cells have a structure in which the electrode assembly is accommodated within a rigid cell case (can) and may be configured in cylindrical, prismatic, or coin-shaped forms.

### SUMMARY

A battery cell uses a sealing gasket to seal a gap between a cap plate and a can so as to prevent leakage of materials inside the cell case. External surfaces of conventional sealing gaskets are coated with tar, but this case may lead to problems such as dust generation from the tar or melting of the tar at temperatures above 30° C., which may cause environmental contamination and reduced sealing performance.

According to an aspect of the present disclosure, contamination caused by a sealing gasket may be prevented.

According to an aspect of the present disclosure, a temperature range of a sealing gasket may be expanded.

According to an aspect of the present disclosure, the leak prevention performance of a sealing gasket may be improved.

According to an aspect of the present disclosure, damage to a sealing gasket during a crimping process may be prevented.

A cap assembly including a sealing gasket, a battery cell including the same and a manufacturing method of the battery cell of the present disclosure may be widely applied to electric vehicles, battery charging stations, and devices within green technology fields such as other battery-powered solar and wind power generation. In addition, a cap assembly including a sealing gasket, a battery cell including the same, and a manufacturing method of the battery cell of the present disclosure may be used in eco-friendly electric vehicles, hybrid vehicles, or the like, to prevent climate change by suppressing air pollution and greenhouse gas emissions.

A battery cell according to the present disclosure may include: a cell case including a sidewall having an accommodating space formed therein and an end plate having a through-hole formed therein; an electrode assembly disposed in the accommodating space of the cell case; and a cap assembly sealing the cell case, and the cap assembly may include: a cap plate covering one side of the accommodating space; and a sealing gasket disposed between the cap plate and the cell case, the cap plate may include a first surface facing the accommodating space, a second surface opposite the first surface, and a third surface connecting the first surface and the second surface in edges of the first surface and the second surface, and the second surface may include an edge region and a central region surrounded by the edge region, and the sealing gasket may be formed integrally with the cap plate by insert injection, so that at least a portion thereof is in contact with the edge region.

According to an embodiment, the sealing gasket may have a ring shape and may include a first portion in contact with the first surface, a second portion extending upwardly from the first portion and in contact with the third surface, and a third portion extending from the second portion and in contact with the second surface.

According to an embodiment, the sealing gasket may be formed of a material having a Young's modulus of 1 GPa or less.

According to an embodiment, the sealing gasket may include at least one of silicone, high-density polyethylene (HDPE), or perfluoroalkoxy alkane (PFA).

According to an embodiment, the cap plate may further include a vent notch, and the vent notch may be formed in the central region not covered by the sealing gasket.

According to an embodiment, the cap plate may be electrically connected to an electrode tab of the electrode assembly.

According to an embodiment may further includes: a current collecting plate electrically connected to an electrode tab of the electrode assembly, and the current collecting plate may be electrically connected to at least one of the cap plate or a sidewall of the cell case.

A manufacturing method of a battery cell, the method may include: an insertion operation of inserting an electrode assembly into a cell case including a sidewall having an accommodating space formed therein and an end plate having a through-hole formed therein; a beading operation of beading the cell case; an installation operation of installing a cap assembly into the cell case, and the cap assembly may include: a cap plate covering one side of the accommodating space; and a sealing gasket disposed between the cap plate and the cell case, the cap plate includes a first surface facing the accommodating space, a second surface opposite the first surface, and a third surface connecting the first surface and the second surface in edges of the first surface and the second surface, the second surface may include an edge region and a central region surrounded by the edge region, and at least a portion of the sealing gasket may be in contact with the edge region and may be formed integrally with the cap plate by insert injection.

According to an embodiment, the manufacturing method of a battery cell may further include: a welding operation of welding a beading portion of the cell case to a current collecting plate, and the welding operation may be performed between the beading operation and the installation operation.

According to an embodiment, the installation operation may include: an insertion operation of inserting the cap assembly in a state in which the sealing gasket and the cap plate are integrated, into the cell case; and a coupling operation of coupling the cap assembly to the cell case.

According to an embodiment, the coupling process may include crimp-coupling the cap assembly and the cell case.

According to an embodiment, the sealing gasket may include at least one of silicone, high-density polyethylene (HDPE), or perfluoroalkoxy alkane (PFA).

A cap assembly according to an embodiment may include: a cap plate covering one side of a cell case accommodating space; and a sealing gasket disposed between the cap plate and the cell case, and the cap assembly may include a first surface facing the accommodating space, a second surface opposite the first surface, and a third surface connecting the first surface and the second surface in edges of the first surface and the second surface, the second surface may include an edge region and a central region surrounded by the edge region; and at least a portion of the sealing gasket may be in contact with the edge region and may be formed integrally with the cap plate by insert injection.

According to an embodiment, the sealing gasket may include at least one of silicone, high-density polyethylene (HDPE), or perfluoroalkoxy alkane (PFA).

According to an embodiment of the present disclosure, contamination caused by a sealing gasket may be prevented.

According to an embodiment of the present disclosure, a management temperature range of a sealing gasket may be expanded.

According to an embodiment of the present disclosure, the leak prevention performance of a sealing gasket may be improved.

According to an embodiment of the present disclosure, damage to a sealing gasket during a crimping process may be prevented.

### BRIEF DESCRIPTION OF DRAWINGS

Certain aspects, features, and advantages of the present disclosure are illustrated by the following detailed description with reference to the accompanying drawings.

FIG. 1 is a perspective view of a battery cell according to an embodiment.

FIG. 2 is a cross-sectional view taken along line I-I′ of FIG. 1.

FIG. 3 is an enlarged view of portion “A” of FIG. 2.

FIG. 4 is a perspective view of a cap assembly according to an embodiment.

FIG. 5 is an exploded cross-sectional view of a cap assembly according to an embodiment.

FIG. 6A and FIG. 6B are photographs obtained by comparing a cross-section of a cap assembly according to an embodiment and a cross-section of a cap assembly including a sealing gasket formed of a PBT material.

FIG. 7 is a cross-sectional view of a battery cell according to another embodiment.

FIG. 8 is a cross-sectional view of a battery cell according to yet another embodiment.

FIG. 9 is a flowchart illustrating a manufacturing method of a battery cell according to an embodiment.

FIG. 10 is a flowchart illustrating an installation operation of a manufacturing method of a battery cell according to an embodiment.

FIG. 11A to FIG. 11D are cross-sectional views illustrating a manufacturing method of a battery cell.

### DETAILED DESCRIPTION

Hereinafter, the present disclosure will be described in detail with reference to the attached drawings. However, these are merely exemplary and the present disclosure is not limited to the specific embodiments described as examples.

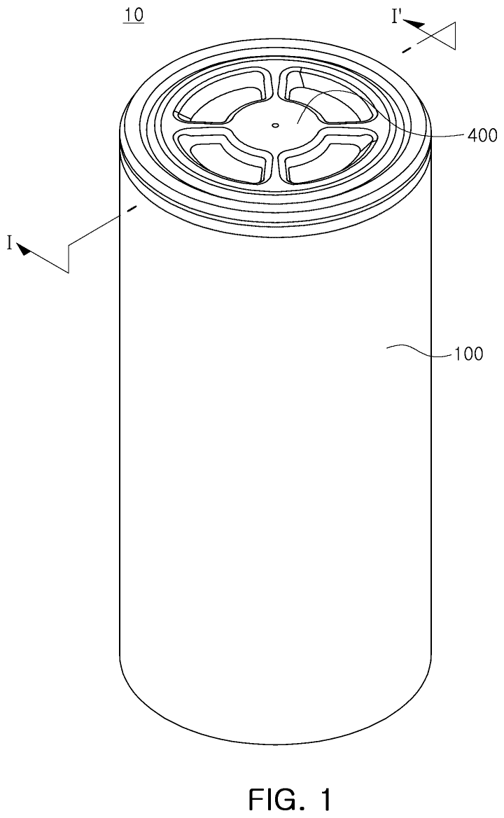

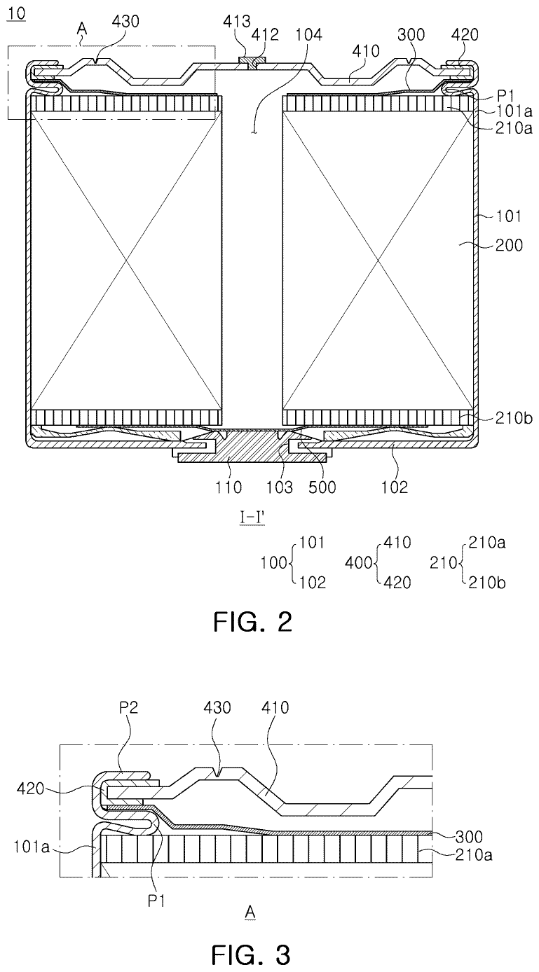

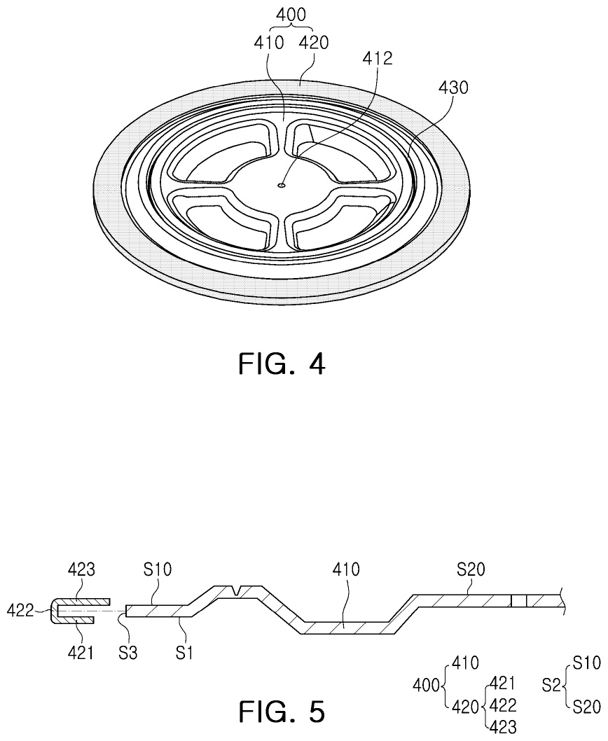

FIG. 1 is a perspective view of a battery cell 10 according to an embodiment. FIG. 2 is a cross-sectional view taken along line I-I′ of FIG. 1. FIG. 3 is an enlarged view of part “A” of FIG. 1.

Referring to FIGS. 1 to 3, a battery cell 10 according to an embodiment may include a cell case 100 including a sidewall 101 having an accommodating space 104 formed therein and an end plate 102 having a through-hole 103 formed therein, and may include and an electrode assembly 200 disposed in the accommodating space 104 of the cell case 100.

The electrode assembly 200 may include a cathode plate, an anode plate, and a separator. The separator may be comprised of an insulator interposed between the anode plate and the cathode plate. The electrode assembly 200 may be configured as a stack type in which the cathode plate, the anode plate and the separator are alternately stacked. Alternatively, the electrode assembly 200 may be configured as a winding type in which the cathode plate, the anode plate, and the separator interposed between the cathode plate and the anode plate are wound in a roll shape. In the present disclosure, the electrode assembly 200 is illustrated as a winding type, but is not necessarily limited thereto.

The cathode plate and the anode plate may each have a structure in which a cathode active material or an anode active material is coated on a foil. For example, the anode plate may be formed by coating graphite or other materials on a foil formed of copper or nickel materials, and the cathode plate may be formed by coating a transition metal oxide active material on a foil formed of an aluminum material.

The electrode assembly 200 may include an electrode tab 210. The electrode tab 210 may include an anode tab 210a and a cathode tab 210b. At least some of the cathode plate and the anode plate may not be coated with an active material. Portions of the cathode plate and the anode plate that are not coated with an active material may refer to non-coated portions. The non-coated portions may protrude vertically. That is, the protruding non-coated portions of the cathode plate and the anode plate may function as the cathode tab 210b and the anode tab 210a, respectively.

The electrode tab 210 of the electrode assembly 200 may be in contact with and may be electrically connected to a current collecting plate 300, and the electrode tab 210 and the current collecting plate 300 may be coupled together by welding, such as ultrasonic welding or laser welding. However, a method of coupling the electrode tabs 210 and the current collecting plate 300 is not limited thereto.

The cell case 100 may accommodate the electrode assembly 200. In other words, the electrode assembly 200 may be accommodated within the cell case 100.

The cell case 100 may include a sidewall 101 having an internal accommodating space 104 formed therein and an end plate 102 having a through-hole 103 formed therein. The accommodating space 104 may be formed by the sidewall 101 and the end plate 102 of the cell case 100. The cell case 100 may have a cylindrical shape in which one side thereof is open. The cell case 100 may have a hollow cylindrical shape with a circular cross-section.

The sidewall 101 may have a tube shape, and the end plate 102 may have a plate shape covering a bottom side of the accommodating space 104. The sidewall 101 may have a circular tube shape. The end plate 102 may have an overall flat plate shape. Thicknesses of the end plate 102 and the sidewall 101 of the cell case 100 may be variously changed. For example, the end plate 102 and the sidewall 101 may have the same thickness, or the thickness of the end plate 102 may be greater than the thickness of the sidewall 101. The cell case 100 may include a metal material such as aluminum or an aluminum alloy, but a material of the cell case 100 may be variously changed.

The sidewall 101 and the end plate 102 of the cell case 100 may be formed integrally. For example, the cell case 100 may be manufactured by deep drawing a metal sheet, thereby forming the sidewall 101 and the end plate 102 integrally. When the cell case 100 is formed integrally, a process of bonding the sidewall 101 and the end plate 102 is not required, so that the manufacturing of the cell case 100 and/or the battery cell 10 may be easily performed and workability may be improved.

However, the cell case 100 of the present disclosure is not limited to a configuration in which the sidewall 101 and the end plate 102 are formed integrally, and the sidewall 101 and the end plate 102 may also be manufactured separately and then coupled or bonded together by welding or other manners.

The through-hole 103 may be formed in the end plate 102 of the cell case 100. The through-hole 103 may be provided for coupling an electrode terminal 110. The cell case 100 has a circular cross-sectional shape, and the through-hole 103 may be formed in a central portion of the end plate 102. In this case, the electrode terminal 110 coupled to the through-hole 103 may be disposed in a central portion of the end plate 102.

The electrode terminal 110 may be coupled to the through-hole 103. At least a portion of the electrode terminal 110 may be exposed to the outside of the cell case 100. In addition, at least a portion of the electrode terminal 110 may be disposed in the accommodating space 104 of the cell case 100 and may be electrically connected to a current collector 500. That is, the electrode terminal 110 may pass through the through-hole 103 and may be electrically connected to the current collector 500. Accordingly, when the current collector 500 is coupled to the cathode tab 210b, the electrode terminal 110 may correspond to the cathode terminal, and vice versa.

The battery cell 10 according to an embodiment may include a cap assembly 400 sealing the cell case 100. The cap assembly 400 may include a cap plate 410 covering one side of the accommodating space 104 of the cell case 100. The cap plate 410 may cover the accommodating space 104 on an opposite side from the end plate 102. That is, the cap plate 410 may seal an opening of the cell case 100.

The cap plate 410 may be coupled to the sidewall 101 of the cell case 100 by crimping, welding, or the like. As an example, a beading process is performed on an open end portion 101a of the sidewall 101 of the cell case 100 to form a beading portion P1, and then, in a state in which the cap plate 410 to which a sealing gasket 420 is coupled is placed on the beading portion P1, the end portion 101a of the sidewall 101 and the cap plate 410 are crimped to form a crimping portion P2.

The cap plate 410 may be provided with a liquid injection port 412 for injecting an electrolyte into the cell case 100. The liquid injection port 412 may be formed in a center of a body 411 of the cap plate 410, but a position and a size thereof may be variously changed. After the electrolyte is injected, the liquid injection port 412 may be sealed with a liquid injection port cover 413.

The cap assembly 400 may include a sealing gasket 420 disposed between the cap plate 410 and the cell case 100.

The sealing gasket 420 may be disposed between the cap plate 410 and the cell case 100 to insulate the cap plate 410 and the cell case 100. The sealing gasket 420 may be disposed between the cap plate 410 and the sidewall 101 of the cell case 100 for sealing. The sealing gasket 420 may serve as a sealing member sealing a space between the cap plate 410 and the sidewall 101.

The sealing gasket 420 may be formed integrally with the cap plate 410 by insert injection. The sealing gasket 420 may be formed to contact at least a portion of the cap plate 410. For example, the sealing gasket 420 may be formed to surround the edge of the cap plate 410. A detailed description of the shape and a manufacturing method of the cap assembly 400, which includes the sealing gasket 420 and the cap plate 410, will be described below.

The battery cell 10 according to an embodiment may further include a current collecting plate 300 electrically connected to the electrode tab 210 of the electrode assembly 200. A lower surface of the current collecting plate 300 may be bonded or in contact with the electrode tab 210 so as to be electrically connected to the electrode tab 210. Welding may be used to bond the current collecting plate 300 and the electrode tab 210. For example, the current collecting plate 300 and the electrode tab 210 may be bonded by ultrasonic welding, laser welding, resistance welding, or the like. Alternatively, the current collecting plate 300 and the electrode tab 210 may be electrically connected while in contact with each other without being bonded.

The current collecting plate 300 may be electrically connected to at least one of the cap plate 410 or the sidewall 101 of the cell case 100. In this case, the cap plate 410 and/or the cell case 100 may have polarity. For example, when the current collecting plate 300 is electrically connected to the anode tab 210a, the cap plate 410 and/or the cell case 100 may be charged to an anode. An object electrically connected to the current collecting plate 300 may be variously changed depending on the design specifications of the battery cell 10.

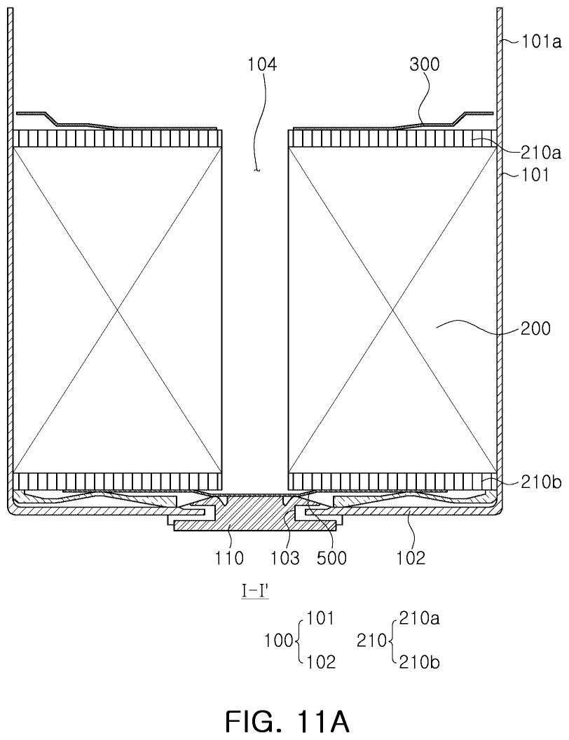

Meanwhile, a configuration in which the current collecting plate 300 is not disposed and the electrode tab 210 is directly electrically connected to the cap plate 410 is also possible (see FIG. 8).

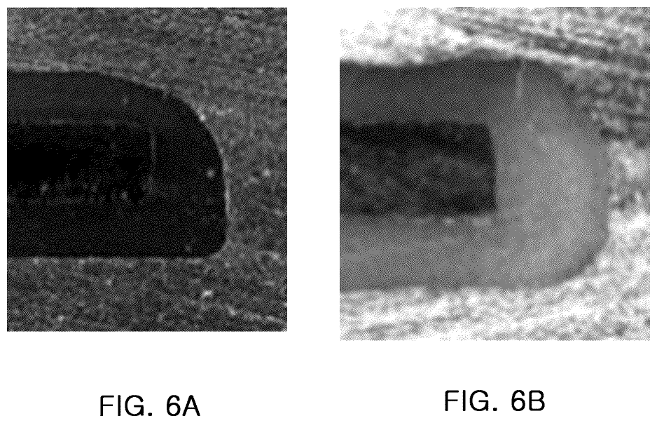

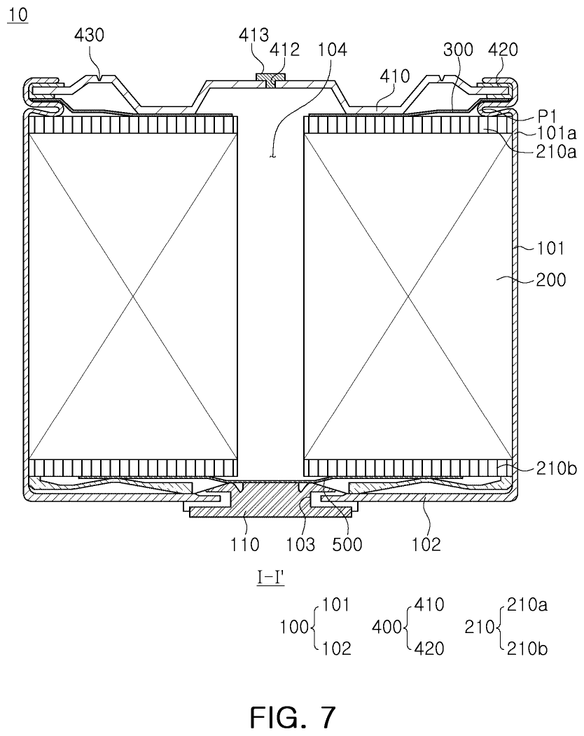

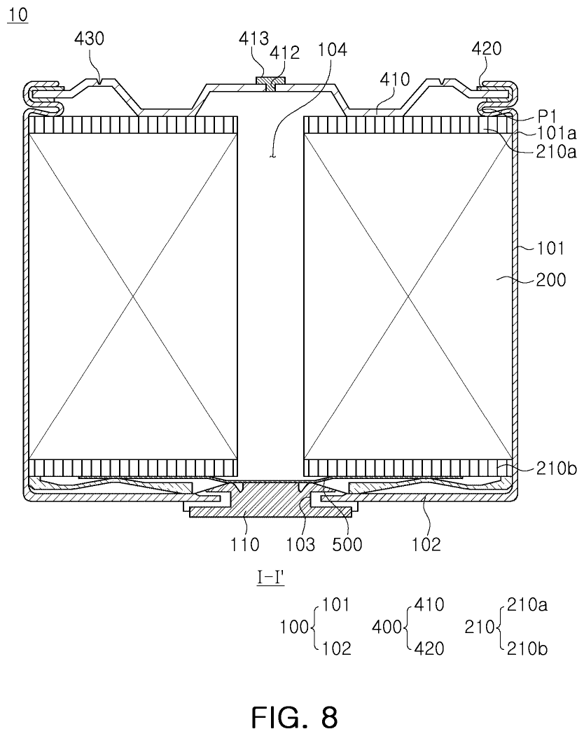

FIG. 4 is a perspective view of a cap assembly 400 according to an embodiment. FIG. 5 is an exploded cross-sectional view of a cap assembly 400 according to an embodiment. FIGS. 6A and 6B are photographs obtained by comparing a cross-section of a cap assembly according to an embodiment with a cross-section of a cap assembly including a sealing gasket formed of a PBT material.

The descriptions of the cap plate 410 and the sealing gasket 420 of FIGS. 1 to 3 may also be applied to FIGS. 4 and 5.

Referring to FIGS. 4 and 5 together with FIG. 3, a cap assembly 400 according to an embodiment may include a cap plate 410 covering one side of the cell case 100 accommodating space 104, and a sealing gasket 420 disposed between the cap plate 410 and the cell case 100.

The cap plate 410 includes a first surface S1 facing the accommodating space 104, a second surface S2 opposite the first surface S1, and a third surface S3 connecting the first surface S1 and the second surface S2 in edges of the first surface S1 and the second surface S2, and the second surface S2 may include an edge region S10 and a central region S20 surrounded by the edge region S10. At least a portion of the sealing gasket 420 may be in contact with the edge region S10, and the sealing gasket 420 may be formed integrally with the cap plate 410 by insert injection.

The edge region S10 may be in contact with at least a portion of the sealing gasket 420. The central region S20 may refer to a region that does not contact at least a portion of the sealing gasket 420. That is, the cap plate 410 may include an edge region S10 in contact with at least a portion of the sealing gasket 420, and a central region S20 surrounded by the edge region S10 and not in contact with at least a portion of the sealing gasket 420. The cap plate 410 may be electrically connected to the electrode tab 210 of the electrode assembly 200 or the current collecting plate 300 through the central region S20 that does not contact at least a portion of the sealing gasket 420, thereby establishing a polarity.

The sealing gasket 420 may have a ring shape. That is, the sealing gasket 420 may include a circular, empty space in a center thereof. Additionally, a longitudinal cross-section of the sealing gasket 420 may include a ‘C’ shape.

The sealing gasket 420 may include a first portion 421 that is in contact with the first surface S1, a second portion 422 extending upwardly from the first portion 421 and in contact with the third surface S3, and a third portion 423 extending from the second portion 422 and contacting the second surface S2. That is, the first portion 421, the second portion 422 and the third portion 423 of the sealing gasket 420 may be formed to be coupled to each other and surround at least a portion of the cap plate 410.

The sealing gasket 420 may be formed integrally with the cap plate 410 by insert injection. That is, the cap assembly 400 may be manufactured by integrally molding the cap plate 410 and the sealing gasket 420 by insert injection, rather than a method of separately manufacturing the cap plate 410 and the sealing gasket 420 and then assembling the cap plate 410 and the sealing gasket 420. This prevents damage to the sealing gasket 420 during the crimping process.

The sealing gasket 420 may be formed of a material that is more elastic than conventional sealing gaskets. The sealing gasket 420 may be formed of a material having a Young's modulus (E) of 2 GPa or less, 1.5 GPa or less, or 1 GPa or less. Since the sealing gasket 420 is formed of a material having a Young's modulus (E) of 1 GPa or less, even if the tar coating is emitted, the sealing gasket 420 having improved sealing performance may be provided.

For example, the sealing gasket 420 may include at least one of silicone (E=0.05 GPa), high-density polyethylene (HDPE) (E=0.9 GPa), or perfluoroalkoxy alkane (PFA) (E=0.58 GPa). That is, as the sealing gasket 420 is formed of a material having a low elastic modulus, the leak prevention performance may be improved.

A leak test has been conducted to compare the sealing performance of each material. The leak test for the battery cell 10 is conducted by increasing the internal pressure of the battery cell 10 by 40 bar and then measuring the pressure inside the battery cell 10 after a certain period of time to inspect whether the battery cell 10 is leaked, and the test result values are shown in the table below.

TABLE 1

| | PBT | PBT | | | |
|---|---|---|---|---|---|
| | (No tar | (Tar | | | Silicone |
| | coating) | coating) | PFA | HDPE | rubber |
| Compression | 10% | 10% | 50% | 40% | 60% |
| rate | | | | | |
| Leak Test | Sealing | Sealing | Sealing | Sealing | Sealing |
| (leak test) | Failure | Failure | successful | successful | successful |
| @40 bar | (sealing | (sealing | (sealing | (sealing | (sealing |
| | NG) | NG) | OK) | OK) | OK) |
| | 20 bar | 29 bar | | | |

The leak test may be performed in a state in which the sealing gasket 420 is compressed under the same pressure. Specifically, compressing the sealing gasket 420 may denote that the cap assembly 400 including the sealing gasket 420 is compressed by the end portion 101a of the cell case 100 while crimp-coupling the cap assembly 400 to the cell case 100.

FIG. 6A is a cross-sectional photograph of a cap assembly 400 including a sealing gasket 420 formed of a PFA material according to an embodiment, and FIG. 6B is a cross-sectional photograph of a cap assembly 400 including a sealing gasket formed of a PBT material.

Referring to FIGS. 6A and 6B, it may be confirmed that the sealing gasket 420 formed of a PFA material according to an embodiment is more compressed than the sealing gasket formed of the PBT material.

The compression rate may refer to a ratio of a reduced thickness of the sealing gasket 420 after pressurization to a thickness before compression by an end of the cell case 100. That is, the compression rate of the sealing gasket 420 of FIG. 6A is greater than the compression rate of the sealing gasket of FIG. 6B.

In the case of a sealing gasket formed of the PBT material without tar coating, the pressure inside the battery cell, which was 40 bar, decreased to 20 bar after a certain period of time. In the case of a sealing gasket formed of the PBT material with tar coating, the pressure inside the battery cell, which was 40 bar, decreased to 29 bar after a certain period of time. In the case of the sealing gasket 420 formed of PFA, HDPE or silicone rubber, the pressure inside the battery cell 10 remained at 40 bar even after a certain period of time. It is confirmed the sealing gasket 420 formed of PFA, HDPE, or silicone rubber has better sealing performance.

In an embodiment, since the sealing gasket 420 is formed of a material more elastic than the cap plate 410, a surface of the sealing gasket 420 may not be coated with tar. By omitting the tar coating, contamination of the manufacturing environment caused by the sealing gasket 420 may be reduced. Furthermore, by omitting the tar coating, the temperature range for the sealing gasket 420 may be expanded. For example, conventional sealing gaskets have a problem with melting of the tar coating in environments having a temperature of 30° C. or more. However, the sealing gasket 420 of the present disclosure may be used in a temperature range of 30° C. to 120° C.

The cap plate 410 may further include a vent notch 430. The vent notch 430 may be formed to induce fracture of the cap plate 410 in response to the internal pressure of the cell case 100. That is, the vent notch 430 may define a fracture position of the cap plate 410. The cap plate 410 may be designed to fracture in a position corresponding to the vent notch 430 to release the internal pressure.

The vent notch 430 may be formed on the second surface S2 of the cap plate 410. The vent notch 430 may be formed by recessing in a thickness direction from the second surface S2 of the cap plate 410 toward the first surface S1, to a predetermined depth. The vent notch 430 may generally have a groove shape formed on the second surface S2 of the cap plate 410. In addition, the vent notch 430 may have a predetermined longitudinal cross-sectional shape. In this embodiment, the vent notch 430 is illustrated as having a longitudinal section of an approximately “V” shape. A portion in which the vent notch 430 is formed may have a thinner thickness than that of a portion in which the vent notch 430 is not formed.

The vent notch 430 may be formed in the central region S20 not covered by the sealing gasket 420. The edge region S10 is in contact with at least a portion of the sealing gasket 420, and the central region S20 does not contact the sealing gasket 420. Since the vent notch 430 is formed in the central region S20 not covered by the sealing gasket 420, when the cap plate 410 fractures due to increased internal pressure within the cell case 100, gas within the cell case 100 may be smoothly discharged to the outside. When the sealing gasket 420 covers all of the first surface S1, second surface S2 and third surface S3 of the cap plate 410, even if the vent notch 430 is formed, gas inside the cell case 100 may not be smoothly discharged to the outside due to the sealing gasket 420.

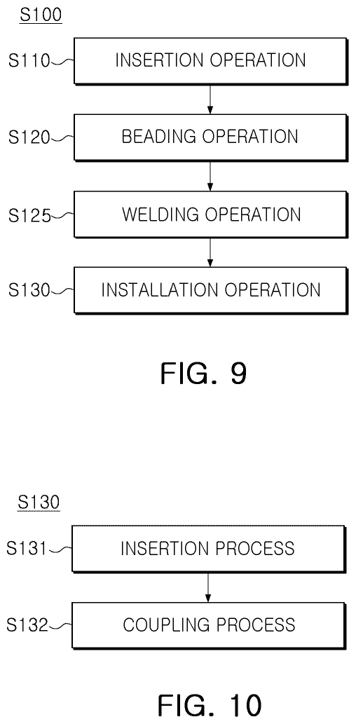

FIG. 7 is a cross-sectional view of a battery cell 10 according to another embodiment.

Compared to the embodiment of FIGS. 1 to 3, the battery cell 10 of FIG. 7 differs in whether the cap plate 410 and the current collecting plate 300 are bonded or not. The descriptions of FIGS. 1 to 3 may also be applied to the battery cell 10 of FIG. 7, and the following description focuses on the differences.

The battery cell 10 illustrated in FIG. 7 may include a cell case 100, an electrode terminal 110, an electrode assembly 200, a current collecting plate 300, and a cap assembly 400.

In an embodiment of FIG. 7, the current collecting plate 300 may be electrically connected to the electrode tab 210. Additionally, the cap plate 410 may be electrically connected to the current collecting plate 300. The cap plate 410 may be coupled to the current collecting plate 300 by welding or the like, and may be thus electrically connected to the current collecting plate 300. Alternatively, the cap plate 410 may be electrically connected to the current collecting plate 300 by applying pressure to the current collecting plate 300 so that the current collecting plate 300 is in contact with the current collecting plate 300.

FIG. 8 is a cross-sectional view of a battery cell 10 according to another embodiment.

As compared to the embodiment of FIGS. 1 to 3, the battery cell 10 of FIG. 8 differs in the presence or absence of a current collecting plate 300 (see FIG. 2). The descriptions of FIGS. 1 to 3 may also be applied to the battery cell 10 of FIG. 8, and the differences will be described below.

The battery cell 10 illustrated in FIG. 8 may include a cell case 100, an electrode terminal 110, an electrode assembly 200, and a cap assembly 400.

In the embodiment of FIG. 8, the cap plate 410 may be electrically connected to the electrode tab 210 of the electrode assembly 200 without the intervening current collecting plate 300 (see FIG. 2). The cap plate 410 may be coupled to the electrode tab 210 by welding or the like, and may thus be electrically connected to the electrode tab 210. Alternatively, the cap plate 410 may be electrically connected to the electrode tab 210 by applying pressure to the electrode tab 210 so that the cap plate 410 is in contact with the electrode tab 210. When the electrode tab 210 is directly electrically connected to the cap plate 410, the current collecting plate 300 (see FIG. 2) may not be disposed.

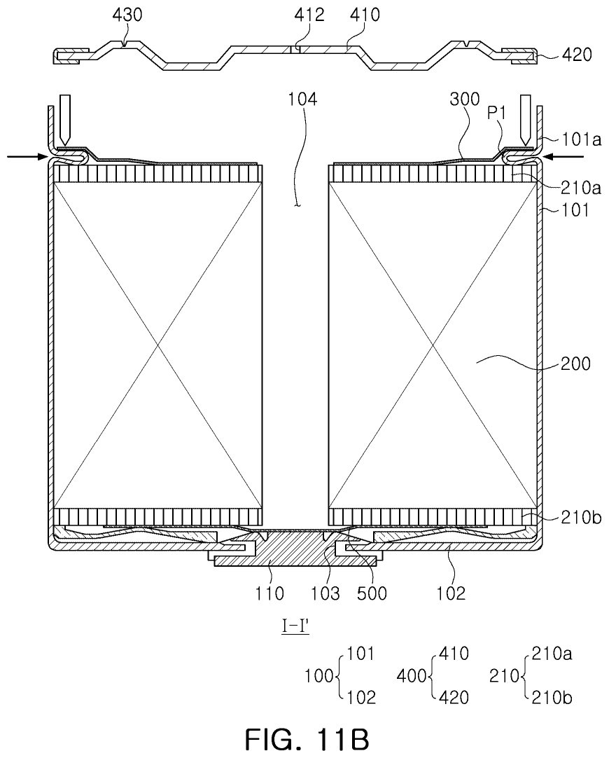

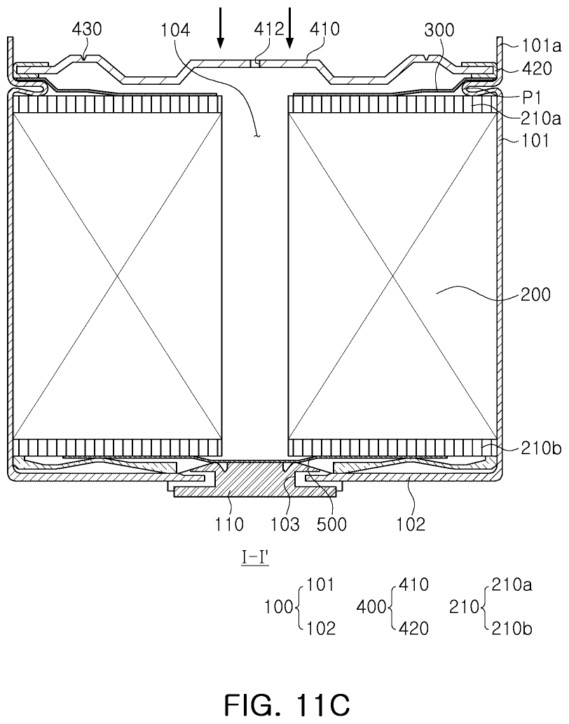

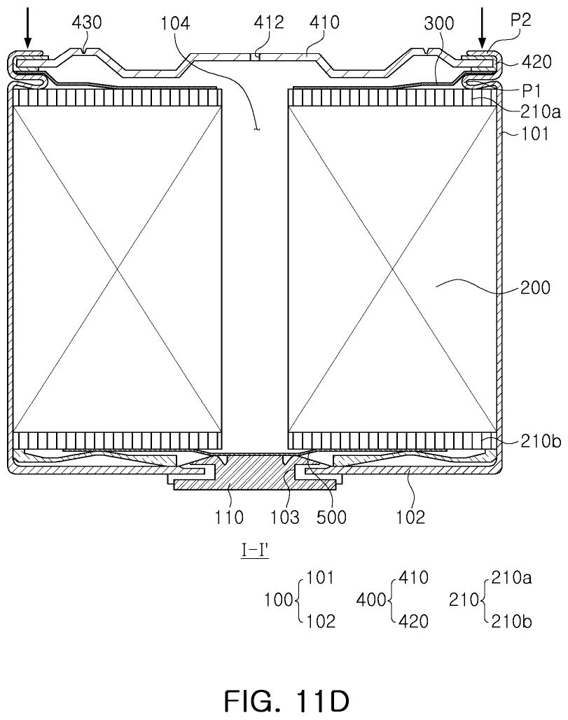

FIG. 9 is a flowchart illustrating a manufacturing method (S100) of a battery cell according to an embodiment. FIG. 10 is a flowchart illustrating an installation operation (S130) of the manufacturing method (S100) of a battery cell according to an embodiment. FIGS. 11A to 11D are cross-sectional views illustrating the manufacturing method (S100) of a battery cell.

FIGS. 11A to 11D illustrate a manufacturing method (S100) of a battery cell illustrated in FIGS. 1 to 3.

Referring to FIG. 9 along with FIGS. 1 to 3, a manufacturing method (S100) of a battery cell according to an embodiment may include an insertion operation (S110) of inserting an electrode assembly 200 into a cell case 100 including a sidewall 101 having an accommodating space 104 formed therein and an end plate 102 having a through-hole 103 formed therein, a beading operation (S120) of beading the cell case 100, and an installation operation (S130) of installing a cap assembly 400 onto the cell case 100. Furthermore, the manufacturing method (S100) of a battery cell may further include a welding operation (S125) of welding the beading portion P1 of the cell case 100 to the current collecting plate 300. The welding operation (S125) may be performed between the beading operation (S120) and the installation operation (S130). The cap assembly 400 may include a cap plate 410 covering one side of the accommodating space 104, and a sealing gasket 420 disposed between the cap plate 410 and the cell case 100. The cap plate 410 may include a first surface S1 facing the accommodating space 104, a second surface S2 opposite the first surface S1, and a third surface S3 connecting the first surface S1 and the second surface S2 in edges of the first surface S1 and the second surface S2. The second surface S2 may include an edge region S10 and a central region S20 surrounded by the edge region S10. At least a portion of the sealing gasket 420 may be in contact with the edge region S10, and the sealing gasket 420 may be formed integrally with the cap plate 410 by insert injection molding.

Referring to FIGS. 9 to 11D, along with FIGS. 1 through 3, a manufacturing method (S100) of a battery cell will be described. The description of the battery cell 10 described with reference to FIGS. 1 through 3 may also be applied to the manufacturing method (S100) of a battery cell.

Referring to FIG. 11A, the manufacturing method (S100) of a battery cell may include an insertion operation (S110) of inserting an electrode assembly 200 into a cell case 100 including a sidewall 101 having an accommodating space 104 formed therein and an end plate 102 having a through-hole 103 formed therein.

Before the electrode assembly 200 is inserted into the cell case 100, the electrode terminal 110 may be coupled to the end plate 102 of the cell case 100. For example, the electrode terminal 110 may be inserted into the through-hole 103 on the outside of the end plate 102 and then coupled to the end plate 102 by a riveting process.

Before the electrode assembly 200 is inserted into the cell case 100, the electrode tab 210 of the electrode assembly 200 and the current collector 500 may be electrically connected. The electrode tab 210 of the electrode assembly 200 and the current collector 500 may be welded. For example, the electrode tab 210 of the electrode assembly 200 and the current collector 500 may be ultrasonic welded, laser welded, or resistance welded.

The order of connecting the electrode terminal 110 to the cell case 100 and the order of electrically connecting the electrode tab 210 of the electrode assembly 200 and the current collector 500 are irrelevant, and may also be performed in parallel.

The cell case 100 may include an opening in a direction opposite to the end plate 102. In the insertion operation (S110), the electrode assembly 200 may be inserted into the accommodating space 104 of the cell case 100 through the opening of the cell case 100. In this case, the electrode assembly 200 may be inserted in a state in which the current collector 500 connected to the electrode tab 210 is disposed to face the electrode terminal 110. That is, the electrode tab 210 of the electrode assembly 200 may include a cathode tab 210b and an anode tab 210a, and when one of the electrode tabs is electrically connected to the current collector 500, the remaining electrode tab 210 may be disposed to face the opening in a direction opposite to the end plate 102.

After the electrode assembly 200 is inserted into the cell case 100, the current collector 500 may be electrically connected to the electrode terminal 110. For example, the electrode terminal 110 and the current collector 500 may be coupled by laser welding.

The current collecting plate 300 may be in contact with and electrically connected to the electrode tab 210 of the electrode assembly 200 that is disposed to face the opening in a direction opposite to the end plate 102. For example, the current collecting plate 300 may be coupled to the electrode tab 210 by welding, such as ultrasonic welding or laser welding. However, the method of coupling the current collecting plate 300 and the electrode tab 210 is not limited thereto.

Referring to FIG. 11B, the method of manufacturing a battery cell (S100) may include a beading operation (S120) of beading the cell case 100. The beading portion P1 may be formed by allowing the end portion 101a of the sidewall 101 to undergoing a beading process. The beading portion P1 is formed using a beading device, and a detailed description of the beading process will be omitted.

According to an embodiment, a method manufacturing (S100) of a battery cell may further include a welding operation (S125) of welding the beading portion P1 of the cell case 100 to the current collecting plate 300. For example, the beading portion P1 and the current collecting plate 300 may be ultrasonic welded, laser welded, or resistance welded. The welding operation (S125) may be performed between the beading operation (S120) and the installation operation (S130). By welding the beading portion P1 and the current collecting plate 300, the cell case 100 may be charged and the current collecting plate 300 may be secured to the cell case 100.

Referring to FIG. 11C, the manufacturing method (S100) of a battery cell may include an installation operation (S130) of installing a cap assembly 400 into a cell case 100. The installation operation (S130) may include an insertion operation (S131) of inserting the cap assembly 400 in a state in which a sealing gasket 420 and a cap plate 410 are integrated, into the cell case 100.

In the insertion operation (S131), the cap assembly 400 may be inserted through an opening in the cell case 100. In this case, the cap assembly 400 may include a cap plate 410 and a sealing gasket 420, and the cap plate 410 and the sealing gasket 420 may be integrated. A process of integrating the cap plate 410 and the sealing gasket 420, i.e., manufacturing the cap assembly 400 through insert injection, may be performed as a separate process from the process of manufacturing the battery cell 10. The second surface S2 of the cap plate 410 may include an edge region S10 and a central region S20 surrounded by the edge region S10. The sealing gasket 420 may surround the edge region S10. Furthermore, the sealing gasket 420 may be formed integrally with the cap plate 410 through insert injection.

The cap assembly 400 may be inserted into the cell case 100 and may be secured to the beading portion P1. A current collecting plate 300 may be disposed between the cap assembly 400 and the beading portion P1. The cap plate 410 may be spaced apart from the current collecting plate 300 and may not be electrically connected thereto. Instead, the current collecting plate 300 may be electrically connected to the end portion 101a of the sidewall 101, so that the cell case 100 may have a polarity. However, the cap plate 410 is not always spaced apart from the current collecting plate 300, and may be in contact with the current collecting plate 300 and thus have a polarity (see FIG. 7).

Referring to FIG. 11D, the installation operation may include a coupling process (S132) of coupling the cap assembly 400 to the cell case 100.

The coupling process (S132) may crimp-couple the cap assembly 400 and the cell case 100. In a state in which the cap assembly 400 is secured to the beading portion P1, the end portion 101a of the sidewall 101 may be processed to crimp the cap assembly 400 and the cell case 100. During the crimping process, a shape of the end portion 101a of the sidewall 101 may be deformed by external force. However, the shape of the sealing gasket 420 may not be deformed by external force during the crimping process. That is, even before the crimp-coupling, the sealing gasket 420 may have a shape in contact with the edge region S10 of the outer surface of the cap plate 410. Since the shape of the sealing gasket 420 is not deformed by the external force during the crimping process, the possibility of damage to the sealing gasket 420 due to stress may be reduced.

The contents described above are merely examples of applying the principles of the present disclosure, and other components may be further included in a scope that does not exceed the scope of the present disclosure. Additionally, some components may be deleted and implemented in the above-described example embodiments, and each of the embodiments may be combined and implemented with each other.

What is claimed is:

1. A battery cell, comprising:
a cell case including a sidewall having an accommodating space formed therein and an end plate having a through-hole formed therein;
an electrode assembly disposed in the accommodating space of the cell case; and
a cap assembly sealing the cell case,
wherein the cap assembly includes:
a cap plate covering one side of the accommodating space; and
a sealing gasket disposed between the cap plate and the cell case,
wherein the cap plate includes a first surface facing the accommodating space, a second surface opposite the first surface, and a third surface connecting the first surface and the second surface in edges of the first surface and the second surface,
the second surface includes an edge region and a central region surrounded by the edge region, and
the sealing gasket is formed integrally with the cap plate by insert injection, so that at least a portion thereof is in contact with the edge region.

2. The battery cell of claim 1, wherein the sealing gasket has a ring shape and includes a first portion in contact with the first surface, a second portion extending upwardly from the first portion and in contact with the third surface, and a third portion extending from the second portion and in contact with the second surface.

3. The battery cell of claim 1, wherein the sealing gasket is formed of a material having a Young's modulus of 1 GPa or less.

4. The battery cell of claim 1, wherein the sealing gasket includes at least one of silicone, high-density polyethylene (HDPE), or perfluoroalkoxy alkane (PFA).

5. The battery cell of claim 1, wherein the cap plate further includes a vent notch, and
the vent notch is formed in the central region not covered by the sealing gasket.

6. The battery cell of claim 1, wherein the cap plate is electrically connected to an electrode tab of the electrode assembly.

7. The battery cell of claim 1, further comprising:
a current collecting plate electrically connected to an electrode tab of the electrode assembly,
wherein the current collecting plate is electrically connected to at least one of the cap plate or a sidewall of the cell case.

8. A manufacturing method of a battery cell, the method comprising:
an insertion operation of inserting an electrode assembly into a cell case including a sidewall having an accommodating space formed therein and an end plate having a through-hole formed therein;
a beading operation of beading the cell case;
an installation operation of installing a cap assembly into the cell case,
wherein the cap assembly includes:
a cap plate covering one side of the accommodating space; and
a sealing gasket disposed between the cap plate and the cell case,
wherein the cap plate includes a first surface facing the accommodating space, a second surface opposite the first surface, and a third surface connecting the first surface and the second surface in edges of the first surface and the second surface,
the second surface includes an edge region and a central region surrounded by the edge region, and
at least a portion of the sealing gasket is in contact with the edge region, and is formed integrally with the cap plate by insert injection.

9. The manufacturing method of a battery cell of claim 8, further comprising:
a welding operation of welding a beading portion of the cell case to a current collecting plate,
wherein the welding operation is performed between the beading operation and the installation operation.

10. The manufacturing method of a battery cell of claim 8, wherein the installation operation includes:
an insertion operation of inserting the cap assembly in a state in which the sealing gasket and the cap plate are integrated, into the cell case; and
a coupling operation of coupling the cap assembly to the cell case.

11. The manufacturing method of a battery cell of claim 10, wherein the coupling process includes coupling the cap assembly and the cell case by crimping.

12. The manufacturing method of a battery cell of claim 8, wherein the sealing gasket includes at least one of silicone, high-density polyethylene (HDPE), or perfluoroalkoxy alkane (PFA).

13. A cap assembly, comprising:
a cap plate covering one side of a cell case accommodating space; and
a sealing gasket disposed between the cap plate and the cell case,
wherein the cap assembly includes a first surface facing the accommodating space, a second surface opposite the first surface, and a third surface connecting the first surface and the second surface in edges of the first surface and the second surface,
the second surface includes an edge region and a central region surrounded by the edge region; and
at least a portion of the sealing gasket is in contact with the edge region, and is formed integrally with the cap plate by insert injection.

14. The cap assembly of claim 13, wherein the sealing gasket includes at least one of silicone, high-density polyethylene (HDPE), or perfluoroalkoxy alkane (PFA).
